(19) United States
(12) Patent Application Publication
(10) Pub. No.: US 2014/0040472 A1
(43) Pub. Date: Feb. 6, 2014

(54) PROVIDING ACCESS TO THE DATA OF A SINGLE DIGITAL BOOK

(71) Applicant: Nicolas Philippe, Paris (FR)

(72) Inventor: Nicolas Philippe, Paris (FR)

(21) Appl. No.: 14/112,186

(22) PCT Filed: Apr. 2, 2012
(86) PCT No.: PCT/FR2012/050708

§ 371 Date: Oct. 16, 2013

(30) Foreign Application Priority Data
Apr. 18, 2011 (FR) 1153339

(51) Int. Cl. H04L 12/24

(52) U.S. Cl. CPC H04L 41/00
USPC 709/225

(57) ABSTRACT

The invention relates to providing access to data of a digital book on a remote server (SER), wherein, in particular, at least one URL address is provided, said URL address pointing to the data of a single digital book. To this end: a) a hardware medium (CA) is provided, said hardware medium comprising a hidden indicator (COD) for a hardware-medium identifier, as well as an indicator for a first portion (URL1) of said URL address; and b) the server correlates the hardware-medium identifier with said data of the single digital book, in order to make the data of said single digital book accessible at a URL address created by the concatenation of said first URL address portion and the hardware-medium identifier.

The invention relates to providing access to data of a digital book, in particular on a remote site.

A terminal, such as a multimedia tablet (ipad®, ebook®, etc.) for example, is usually equipped with means for connecting to a remote site which allow a user to access data of a digital book in order to download it (as a pdf file for example, downloaded and stored in the tablet memory) or view it online (in epub format for example, which is a type of xml format). “Digital book” is understood to mean a multimedia document containing text to be read (novels, textbooks, conference proceedings, or other documents) accompanied by images which are possibly interactive.

More specifically, the user has access rights to an online store of digital books. Currently, such access rights are granted by purchasing a prepaid card, and the user can choose to have access to one or more books from among the multiple books the store contains. Such an implementation forces the user to navigate around the remote site in order to select the exact book he or she wants, which can be a tedious process, especially when the complete list of books is all jumbled together on the site or if a book is not archived under an expected heading.

The invention aims to improve the situation.

For this purpose, it proposes a method for providing access to data of a digital book on a remote server, wherein at least one URL address (for “Uniform Resource Locator”) for a server resource is provided which provides access to the data of the digital book.

In the invention, at least one URL address pointing to the data of a single digital book is provided, this approach being unlike the approach known in the prior art.

In particular, the method comprises the following steps:
a) providing a hardware medium, such as a plastic card for example, comprising hidden information indicating a hardware-medium identifier, as well as information indicating a first portion of said URL address,
b) establishing a correlation, on the server, between the hardware-medium identifier and said data of the single digital book, in order to make said data of the single digital book accessible at a URL address created by concatenating said first URL address portion and the hardware-medium identifier.

Thus a user having a hardware medium can enter at his terminal (for example by typing on a keyboard interface):
the first URL address portion,
adding at the end of the address a code corresponding to the hardware-medium identifier (as it appears for example under a scratch-off strip arranged on a medium such as a cardboard or plastic card),
and connecting to the site by making use of said server, at that URL address, to access the data of the single digital book that the user is looking for.

Of course, steps a) and b) above can be performed in any order, for example one after the other or in parallel.

In one example embodiment, the hardware-medium identifier can be hidden by a strip which the user scratches off. In such an embodiment, it can be arranged so that step b) is carried out prior to step a). For example, the URL addresses created from the first address portion and the card identifier can be generated at the server, and subsequently or in parallel, the cards can be printed with their own specific identifier.

In this case, the user scratches off the strip on his card to uncover its card identifier (typically a set of alphanumeric characters, for example “copy number N”), types on his terminal the first URL address portion (for example “http://myspecificbook/”) and the rest of the address given by this identifier (in this example “http://myspecificbook/copy number N”), and can then access the specific book corresponding to his card.

Alternative embodiments are possible, however. For example, the card identifier can remain hidden to the user, at least initially.

In such an embodiment, it can be arranged that step a) precedes step b). The hardware medium then comprises a code corresponding to said hardware-medium identifier. This code (for example a barcode or an RFID tag code) is then intended to be read by decryption means (typically an optical reader provided to a bookstore cashier). These code decryption means comprise a link to the remote server and are able to order the server to create a URL address containing:
said first address portion,
concatenated with the card identifier read by the decryption means.

Once a valid URL link is created in this manner, the cashier can then give the user the code for the card or email this code to the user.

It can be arranged, for example, that the code is read at checkout after the card has actually been purchased by the user.

Of course, to prevent fraudulent reuse of the same card by multiple successive users, it can be arranged so that the data of the digital book can only be downloaded once from the site and that the URL address corresponding to this card is permanently erased on the server after a single download (or a finite number of downloads).

In such an implementation, it is then advantageous to associate a unique card identifier with a purchased card.

In particular, in the context of the invention, a plurality of URL addresses pointing to the data of said single digital book are provided, and:
in step a), a plurality of hardware media are provided each containing the hidden information indicating an identifier specific to the hardware medium,
and in step b), each hardware-medium identifier is correlated on the server with said data of the single digital book, in order to make the data of said book accessible at a plurality of respective URL addresses each created by concatenating said first URL address portion and an identifier specific to the hardware medium.

In addition, it can be arranged so that the remote server contains a database of accesses provided to the digital book data at each URL address, to control the number of downloads for example associated with the same card identifier.

Said decryption means may also be connected to a memory storing at least the data on the transmission of identifiers to the server, which allows cross-checking the data in this memory with the data in the server database.

Thus the card can contain the information indicating a URL address, a card code, and possibly a scratch-off area hiding the card's secret code. Validation of the corresponding URL link on the server can be done at checkout, after payment and after the card code has been read electronically. Then the user can scratch off his card to uncover the card code. Then by typing the URL address mentioned on the card into the browser on his terminal, followed by the secret code, the server is requested in a valid manner via this URL link to provide access to the digital file (pdf or xml) that was prepurchased with the card.

Optionally, the user may be asked, prior to accessing the digital book, to provide his email address for example in order to be informed of updates to the book.

The secret code of each card is stored in the database of the contacted server. Activation of the card by the bookstore (information stored in other memory as indicated above) allows cross-checking in case of an anomaly.

For example, specific rights (number of downloads, period of validity, etc.) can be designed for holders of certain cards. It is thus possible to personalize access to a digital book, through a dedicated hardware medium. One can thus assure traceability specific to a user, from the acquisition of the hardware medium to the download. For example, each hardware medium can be marked with the identity of its holder. Typically a secret code specific to a given person can be assigned prior to production of the hardware medium. Activation of the code for this user on the server generates a unique URL link, where a book file dedicated to this user is made available and which may have personalization on the first page, for example “book published expressly for Mr. xxx”.

Such traceability offers multiple advantages: personalization of the asset, protection against illegal downloading, etc.

The server manages and calculates the permissions for each secret code of a card (for example a limit to the number of downloads). In particular, it manages the correlation between a card identifier and a generic URL address in the sense of the invention in order to create, by concatenating these two elements, a URL address specific to the card and where the data of the digital book are accessible.

The invention also relates to such a server for digital book data, for implementing the above method and comprising, in particular, means for creating URL addresses which are each specific to a single book.

More specifically, in one particular embodiment the URL addresses are each specific to a single book and to a single hardware medium.

Of course, a computer program can be implemented for creating such URL addresses. The present invention also relates to a computer program comprising instructions for implementing step b) of the above method when this program is executed by the processor of a server in the sense of the invention.

The invention also relates to a hardware medium (such as a card) for implementing the invention and comprising at least a first URL address portion and hidden information indicating the hardware-medium identifier.

The invention offers numerous advantages when implemented. The bookstore does not have to allow for excessive shipping and handling costs because a simple card is used, nor the larger space requirements of a physical book. In addition, the electronic version of a book has much more visibility in a bookstore than on a web site. The reader can benefit from bookstore recommendations and satisfy an impulse.

Other features and advantages of the invention will be apparent from the following detailed description, and from the accompanying drawings in which:

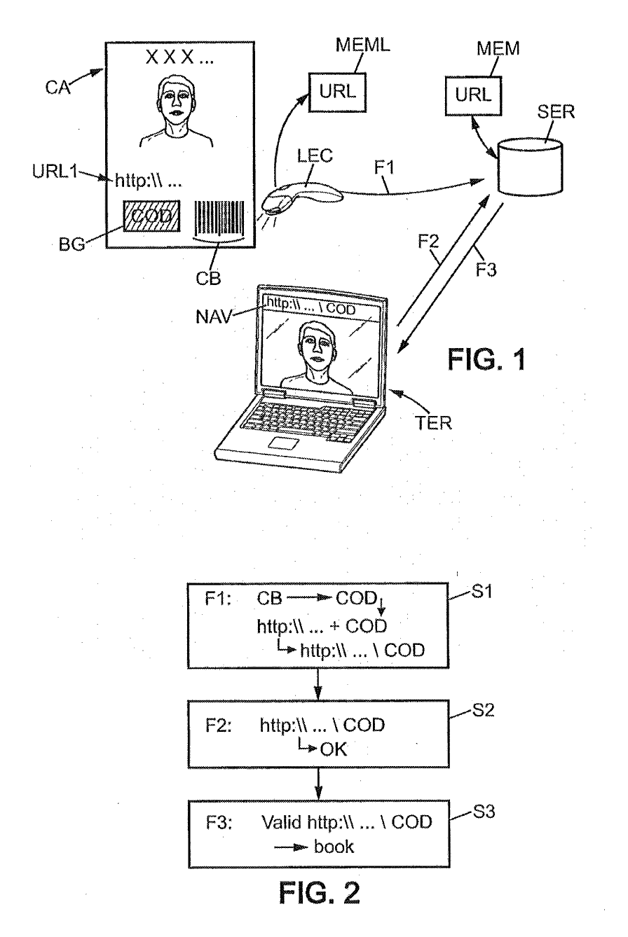

FIG. 1 schematically illustrates an example architecture of a system implementing the invention,

FIG. 2 is an example flowchart illustrating the steps of the method of the invention.

With reference to FIG. 1, the hardware medium in the sense of the invention is in the form of a plastic card CA (credit card format for example), possibly displayed vertically in order to resemble a book cover. It may, for example, be glued onto a cardboard support bearing for example the name of the author and the book title (XXX) and an image corresponding to the book's front cover, for example.

The card CA additionally contains a first URL address portion, denoted URL1, as well as, in the example described, a reference identifier for the card COD, hidden by a strip BG to be scratched off by the user after purchase. Optionally, it additionally bears, in the example represented, a barcode CB which can be read by card identifier decryption means LEC. These decryption means LEC, for example an optical barcode reader provided to a bookstore cashier, contain a connection to the remote server in the sense of the invention, denoted SER.

The server SER is connected to memory MEM and to a processor which constructs URL links by concatenating said first URL address portion with the identifier COD of each card placed on the market. The memory MEM can typically store a database for verifying server connections and access rights associated with the cards.

Thus a user having card CA, after scratching off the strip BG, reveals the code COD and types into the browser bar NAV, using his terminal TER, the complete URL address corresponding to the first portion URL1 followed by the identifier COD for his card. The terminal TER can be any type of electronic medium which is able to connect to the internet (tablet, computer, smart phone).

It may advantageously be arranged so there is local memory MEML connected to the decryption means LEC, for storing the transactions of the card CA and in particular for cross-checking the data contained in this local memory MEML and the data contained in the general memory MEM of the server SER.

In FIG. 2, a first step S1 consists of reading the barcode CB in order to deduce the identifier COD of the card, and sending this to the server SER (arrow F1 in FIG. 1). The server SER then associates the identifier COD with the first address portion URL1 in order to create a complete URL address containing:
the first address portion URL1, followed by
the identifier COD for the card.

This URL address is stored in the database MEM and the data of the digital book corresponding to the card CA then become accessible at this URL address.

Thus, in step S2, when the user enters in the browser bar NAV the complete URL address corresponding to the first address portion URL1 followed by the identifier COD for his card, his terminal successfully connects (“OK”) to the server SER (arrow F2 in FIG. 1), because the complete URL address was created earlier. In the next step S3, the server SER, depending on the content of the database stored in memory MEM, approves if applicable the request made by the terminal TER by providing access to the data of the digital book (“book”) corresponding to the card CA (arrow F3 in FIG. 1). These data may be provided as a pdf file download or simply by providing access to the epub format (a type of xml or html format).

Of course, the invention is not limited to the embodiment described above as an example; it extends to other variants.

For example, the barcode reader CB is optional. In one variant, the URL addresses for each card CA were previously created and are listed in the memory MEM.

The barcode itself is an example embodiment. As a variant, the card may be in the form of an RFID tag and reading it allows communicating the card identifier COD to said server SER.

1. A method for providing access to data of a digital book on a remote server, at least one URL address of a resource of said server being provided to access to said data, wherein at least one URL address pointing to the data of a single digital book is provided, and wherein the method comprises the steps of:
a) providing a hardware medium comprising hidden information indicating a hardware-medium identifier, as well as information indicating a first portion of said URL address, and
b) establishing a correlation, on said server, between the hardware-medium identifier and said data of the single digital book, in order to make said data of the single digital book accessible at said at least one URL address, said at least one URL address being created by concatenating said first URL address portion and the hardware-medium identifier.

2. A method according to claim 1, wherein the hardware-medium identifier is hidden by a strip to be scratched off by the user.

3. A method according to claim 1, wherein step a) precedes step b), wherein the hardware medium comprises a code corresponding to the hardware-medium identifier, and wherein said code is intended to be read by decryption means comprising a communication link to the remote server and able to order the server to create a URL address containing said first address portion concatenated with the hardware-medium identifier that was read.

4. A method according to claim 1, wherein a plurality of URL addresses pointing to the data of said single digital book are provided, and wherein:
in step a), a plurality of hardware media are provided, each containing the hidden information indicating an identifier specific to the hardware medium,
and in step b), each hardware-medium identifier is correlated on the server with said data of the single digital book, in order to make said data of the single digital book accessible at a plurality of respective URL addresses each created by concatenating said first URL address portion and an identifier specific to the hardware medium.

5. A method according to claim 1, wherein the remote server contains a database of accesses provided to the digital book data at each URL address.

6. A method according to claim 3, wherein the decryption means are connected to a memory storing at least the data on the transmission of identifiers to the server, so as to cross-check the data in this memory with the data in a database of server access permissions.

7. A server for digital book data, for implementing the method according to claim 1, wherein the server comprises a memory for creating URL addresses which are each specific to a single book.

8. A server according to claim 7, wherein the URL addresses are each specific to a single book and to a single hardware medium.

9. A computer program comprising instructions for implementing step b) of the method according to claim 1, when this program is executed by a processor of a server.

10. A hardware medium comprising information indicating a first URL address portion and hidden information indicating a medium identifier, for implementing the method according to claim 1.
